(19) United States
(12) Patent Application Publication
(10) Pub. No.: US 2026/0221846 A1
(43) Pub. Date: Jul. 30, 2026

(54) Electric Machine with Cooling System

(71) Applicant: AGCO POWERR OY, Linnavuori (FI)

(72) Inventors: Jouko Jaakko Järvinen, Linnavuori (FI); Juha Pyrhönen, Linnavuori (FI)

(21) Appl. No.: 19/143,693

(22) PCT Filed: Nov. 30, 2023
(86) PCT No.: PCT/IB2023/062062

§ 371 Date: Jun. 26, 2025

(30) Foreign Application Priority Data
Dec. 28, 2022 (GB) 2219777.6
Jan. 23, 2023 (GB) 2300984.8

(51) Int. Cl. H02K 9/197; H02K 1/14; H02K 9/22; H02K 11/01; H02K 11/33

(52) U.S. Cl. CPC H02K 9/197; H02K 1/14; H02K 9/227; H02K 11/01; H02K 11/33

(57) ABSTRACT

An electric machine includes a cooling system for cooling at least one winding and electronics of the electric machine. A fluid cover is attached to the carrier of the stator for enclosing a volume. The at least one winding and the electronics may be cooled according to a method.

### FIELD

The present disclosure relates generally to a cooling system for an electric machine.

### BACKGROUND

An electric machine such as an electric motor or an electric generator comprises components such as power electronics or windings that create losses and therefore heat up when the electric machine is in operation. The heat will cause damage to the electric machine if neither the heat of the power electronics nor the heat of the windings is dissipated.

### BRIEF SUMMARY

It is an objective to provide a common cooling system for cooling both windings and electronics of an electric machine so that windings and electronics can be cooled by the same cooling system instead of integrating separate cooling systems for each component in the electric machine.

According to an aspect of the invention there is provided an electric machine comprising a rotor, a stator and a cooling system. The stator comprises a carrier, at least one winding and electronics. The cooling system is configured for cooling the at least one winding and the electronics. The cooling system comprises a fluid cover attached to the carrier of the stator for enclosing a volume.

The electric machine may be an electric motor or an electric generator. The rotor may be equipped with permanent magnets or excitation coils. The at least one winding may generate a magnetic field to rotate the rotor about a rotation axis of the electric machine. The volume may be filled with a cooling fluid for cooling the at least one winding and the electronics. The fluid cover may be fixed to the carrier, e. g. by screws, glue, crimp or any other fixation, and sealed to avoid cooling fluid leaks out of the stator of the electric machine. The fluid cover may be designed in a manner that the cooling fluid may get in contact with the at least one winding or the electronics for dissipating heat from both components. The cooling fluid may be a coolant or an oil wherein the cooling fluid may be dielectric and non-corrosive to the at least one winding or the electronics. Thus, the cooling system can be used as a common cooling system for cooling both windings and electronics of the electric machine.

The electric machine may comprise an air gap between the stator and the rotor wherein the fluid cover comprises an outer wall extending axially along the air gap.

An electromagnetic main flux generated by the magnets of the rotor and the at least one winding of the stator may travel through the air gap as well as through the outer wall. The outer wall of the fluid cover may be very thin to keep the air gap and losses in the fluid cover small.

The fluid cover may be designed as an electromagnetic interference (EMI) shield.

Thus, any electromagnetic disturbances caused by the operation of the electric machine or the (power) electronics can be avoided outside the fluid cover. The fluid cover may comprise a material having properties appropriate for electromagnetic interference shielding such as copper, aluminum, carbon particles or a copper nickel zinc alloy. The structural design of the outer wall may also provide electromagnetic interference shielding capabilities.

The outer wall may be electrically limitedly conducting.

Thus, the part of the fluid cover designed as outer wall may be electrically limitedly conducting wherein the other part of the fluid cover may have capability of an electromagnetic interference (EMI) shield. The part of the fluid cover being electrically limitedly conducting may be limited to the part of the fluid cover that extends axially along the air gap. I. e., different parts of the fluid cover may have different conductivity. Losses in the fluid cover can be kept small.

The at least one winding may be attached to the fluid cover.

The fluid cover may comprise a stable structure for attaching the at least one winding to the fluid cover (instead to the carrier). The at least one winding may be preassembled in the fluid cover and integrated in the stator by attaching the fluid cover to the carrier. The stable structure may also connect the outer wall with the carrier.

The at least one winding and the electronics may be arranged in the volume.

Then, the at least one winding and the electronics may get in direct contact with the cooling fluid for dissipating the heat. For example, the at least one winding and the electronics may be immersed in the cooling fluid filled in the volume.

The cooling system may comprise at least one fluid flow guide arranged in the volume for conducting a cooling fluid.

The at least one fluid flow guide may be fed by a cool cooling fluid. The fluid flow guide may comprise a flow guide channel to guide the cooling fluid to the electronics or the at least one winding to bring the cooling fluid in contact with the electronics or the at least one winding for dissipating the heat generated by the electronics or the at least one winding. The cooling fluid heated up due to the dissipation may flow through the fluid flow guide to transport the dissipated heat away from the electronics, magnetic core or the windings.

The at least one fluid flow guide may be arranged between the at least one winding and the electronics.

Thus, the cooling fluid may firstly dissipate heat generated by the electronics and secondly dissipate heat generated by the at least one winding and its magnetic core since the at least one winding may tolerate a higher temperature of the cooling fluid than the electronics.

The volume may comprise a first partial volume and a second partial volume wherein the at least one fluid flow guide may be arranged between the first and the second partial volume.

Thus, the fluid flow guide may divide the volume into the first and the second partial volume. The fluid flow guide may be sealed in respect of the first or the second partial volume to avoid that cooling fluid may flow from first partial volume to the second first partial volume or vice versa.

The at least one winding may be arranged in the first partial volume and the electronics may be arranged in the second partial volume.

The first partial volume may be filled with the cooling fluid to immerse the at least one winding in the cooling fluid. Since the first partial volume is smaller than the volume, less cooling fluid may be needed to immerse the at least one winding in the cooling fluid compared to immersing the at least one winding into the volume filled with cooling fluid. The second partial volume may be free of cooling fluid.

The at least one fluid flow guide may be configured to dissipate heat generated by the electronics to a cooling fluid.

So, the electronics may be cooled by the cooling fluid flowing through the fluid flow guide.

The at least one fluid flow guide may comprise an inlet, an outlet and at least one heat sink arranged between the inlet and the outlet.

The cooling fluid may enter the fluid flow guide through the inlet and flow out through the outlet. When the cooling fluid flows form the inlet to the outlet it may get in contact with the at least one heat sink to dissipate heat from the heat sink to the cooling fluid and transport the heat away from the heat sink.

The at least one heat sink may be mechanically connected with the electronics.

Thus, heat generated by the electronics may be conducted to the at least one heat sink. Then, the electronics may be cooled when the heat conducted to the at least one heat sink is dissipated from the at least one heat sink to the cooling fluid.

The electronics may comprise at least one power electronic component wherein the at least one heat sink may be mechanically connected to the at least one power electronic component.

Thus, heat generated by the at least one power electronic component of the electronics may be conducted to the at least one heat sink. The at least one power electronic component may be a MOSFET, an IGBT or any other power switching element. Other components of the electronics as for example components of a control electronics may also be connected with at least one heat sink for dissipating heat.

The cooling system may comprise a connecting channel connected with the at least one fluid flow guide for conducting the cooling fluid after a dissipation of the heat generated by electronics to the at least one winding.

The connecting channel may be connected to the outlet of the fluid flow guide and the first partial volume so that the cooling fluid may flow out of the fluid flow guide into the first partial volume. Since the at least one winding may be arranged in the first partial volume the cooling fluid may firstly cool the electronics by flowing through the fluid flow guide and then cool the at least one winding.

The cooling system may comprise an outtake channel for conducting the cooling fluid away from the at least one winding wherein the at least one winding may be arranged between the connecting channel and the outtake channel for conducting the cooling fluid along the at least one winding.

When the cooling fluid flows along the at least one winding it may get in contact with the at least one winding so that heat generated by the at least one winding may be dissipated from the at least one winding to the cooling fluid. The cooling fluid may flow from the connecting channel to the outtake channel to transport the heat away. Then, the cooling fluid may be cooled by a heat exchanger and conducted to the inlet of the fluid flow guide to provide a closed cooling circuit.

The electric machine may comprise at least two windings wherein the connecting channel may comprise a flow divider having a separate outlet for each of the at least two windings for conducting the cooling fluid separately between the at least two windings.

The flow divider may distribute the cooling fluid equally to the at least two windings so that approximately the same amount of cooling fluid is provided for each of the at least two windings. Thus, an overheating of one of the at least two windings due to an insufficient amount of cooling fluid may be prevented.

The cooling system may comprise at least two fluid flow guides and an intake channel connected with the at least two fluid flow guides for distributing the cooling fluid to the at least two fluid flow guides.

The intake channel may distribute the cooling fluid equally to the at least two fluid flow guides so that approximately the same amount of cooling fluid is provided for each of the at least two fluid flow guides. Thus, an overheating of the electronics due to an insufficient amount of cooling fluid provided to a fluid flow guide may be prevented.

The at least two fluid flow guides may be arranged circumferentially about a rotation axis of the electric machine.

The stator may have a circular shape. Thus, the circumferential arrangement of the at least two fluid flow guides may provide a compact design of the cooling system so that the cooling system may be easily integrated in the stator of the electric machine.

Another aspect includes a method of cooling electronics and a winding of an electric machine wherein the method comprises the steps of conducting a cooling fluid through a fluid flow guide for dissipating heat generated by the electronics to the cooling fluid, conducting the cooling fluid through a connecting channel from the fluid flow guide to the winding and conducting the cooling fluid along the winding for dissipating heat generated by the winding.

Thus, the method provides a single cooling circuit for cooling both electronics and at least one winding of an electric machine. I. e., the cooling fluid used for dissipating heat from the electronics is also used to dissipate heat from the at least one winding.

A further aspect provides an electric machine as described above comprising a pump wherein the cooling system is configured to carry out the method of cooling electronics and a winding of an electric machine.

The pump may transport the cooling fluid from a reservoir to the intake of the at least one fluid flow guide. The pressure generated by the pump may cause the cooling fluid to be conducted through the fluid flow guide for dissipating heat from the electronics. Then, the pressure may cause the cooling fluid to be conducted from the outlet of the fluid flow guide via the connecting channel to the first partial volume where the at least one winding is arranged. The pressure of the pump may cause the cooling fluid to flow from the connecting channel to the outtake channel wherein the cooling fluid dissipates heat generated by the at least one winding arranged between the connecting channel and the outtake channel. When the cooling fluid flows out of the outtake channel it may be collected in the reservoir so that a closed cooling circuit may be provided.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates a sectional view of an electric machine.

FIG. 2 illustrates a sectional view of the electric machine of FIG. 1.

FIG. 3A illustrates an exploded view of a fluid flow guide.

FIG. 3B illustrates an exploded view of the fluid flow guide of FIG. 3A.

FIG. 4 illustrates a sectional view of a rotor of the electric machine of FIG. 1.

FIG. 5 illustrates the electric machine of FIG. 1.

FIG. 6 illustrates a flow chart of a method.

### DETAILED DESCRIPTION

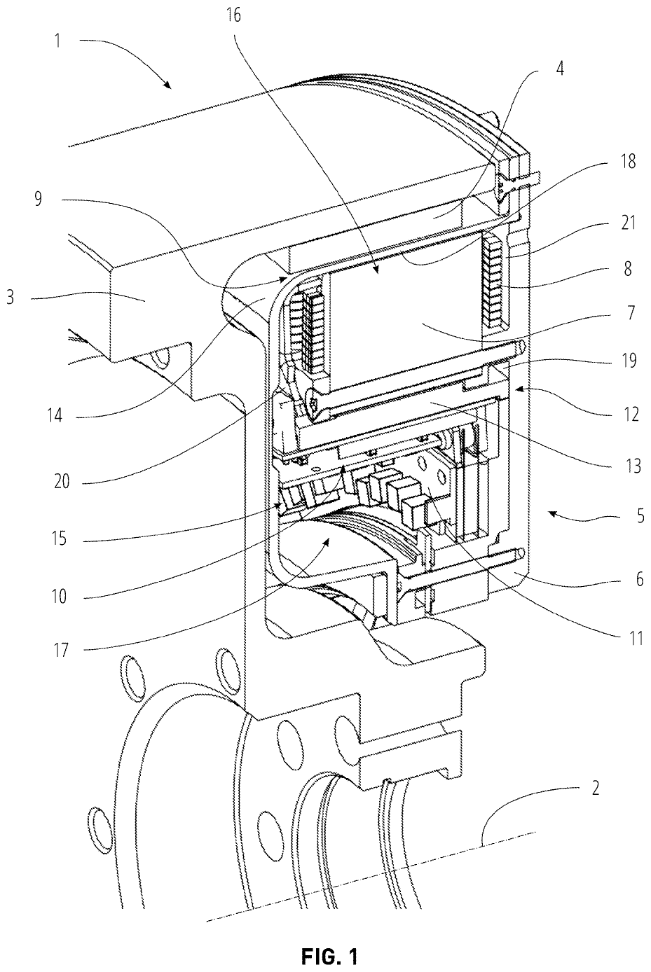

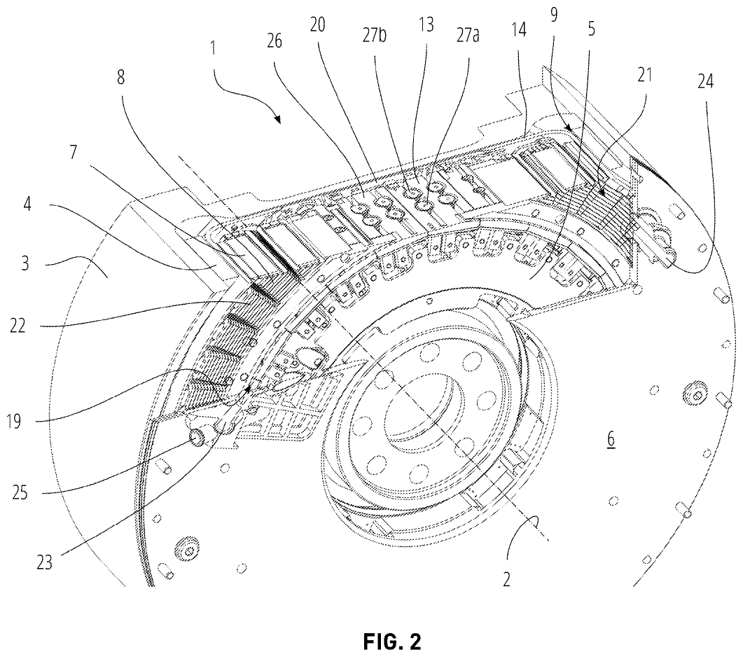

FIG. 1 and FIG. 2 illustrate an electric machine 1 with a rotation axis 2. The electric machine 1 comprises a rotor 3 and a stator 5 and may operate as a motor or as a generator. In the figures, the electric machine 1 is designed as an external rotor machine. The rotor 3 is mounted rotatable about the rotation axis 2. Permanent magnets such as magnet 4 are fixed to an annular inner side of the external rotor 3. The stator 5 comprises a circular carrier 6 for attaching additional components of the electric machine 1. The stator 5 comprises windings wound around corresponding teeth belonging to a magnetic circuit of the electric machine 1 such as winding 8 wound around tooth 7. The teeth are attached to a magnetic yoke which is attached to the carrier 6. Electromagnetic main flux generated by the magnets of the rotor 3 and the windings of the stator 5 may travel through an air gap 9 located between the teeth of the stator 5 and the magnets of the rotor 3 for interacting with a magnetic field of the magnets and creating an electromotive force (EMF).

The stator 5 comprises also electronics 10 for controlling the electric machine 1. The electronics 10 or parts thereof can be attached to the carrier 6. The carrier 6 comprises a cable duct 25 through which signal lines, DC power supply or other cables connected with the electronics 10 can be guided out of the stator 5.

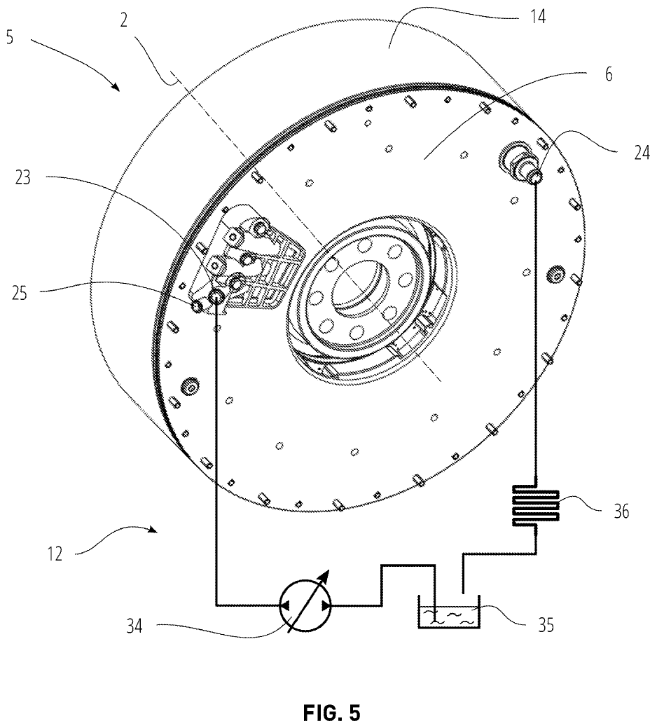

The electric machine 1 comprises a cooling system 12 for dissipating heat generated by the electronics 10 and the windings to a cooling fluid such as distilled water or oil. The cooling system 12 comprises several components. As depicted in FIG. 5, a pump 34 of the cooling system 12 can pump a cooling fluid out of a reservoir 35 through an intake 23 fixed to the carrier 6. The pump 34 is adjustable to adjust the flow of the cooling fluid. The intake 23 is connected with an intake channel 19 located inside the electric machine 1 for conducting the cooling fluid into the electric machine 1. The cooling fluid can run out of the electric machine 1 through a discharge 24 fixed to the carrier 6 and flow back to the reservoir 35. The cooling fluid running out of the electric machine 1 may be cooled by a heat exchanger 36 arranged between the discharge 24 and the reservoir 35 (see FIG. 5).

The cooling system 12 comprises a fluid cover 14 enclosing a volume 15 in the electric machine 1. The fluid cover 14 is fixed to the carrier 6 of the stator 5 and forms with the carrier 6 a hollow body having a ring shape or a shape similar to a torus. The fluid cover 14 prevents the cooling fluid from leaking out of the stator 5. Since the fluid cover is fixed to the carrier 6, the fluid cover 14 could optionally be used to attach the windings of the electric machine 1.

A radial outer wall 18 of the fluid cover 14 extends along the air gap 9 as can be seen in FIG. 1. The fluid cover 14 is designed as an electromagnetic interference (EMI) shield. The fluid cover 14 comprises a material having properties appropriate for electromagnetic interference shielding such as copper, aluminum, carbon particles or a copper nickel zinc alloy. The outer wall 18 may be designed as an electrically limitedly conducting part of the fluid cover 14. Thus, the fluid cover 14 may have different electrical conductivity. Otherwise, the outer wall 18 may be designed as an electromagnetic interference (EMI) shield as the rest of the fluid cover 14.

The cooling system 12 comprises multiple fluid flow guides such as fluid flow guide 13 and fluid flow guide 26 (see FIG. 2). The fluid flow guides (13, 26) are arranged circumferentially about the rotation axis 2 of the electric machine 1. More specifically, the fluid flow guides are arranged annularly in the volume 15 and divide the volume 15 in a first partial volume 16 and a second partial volume 17 as can be exemplarily seen in FIG. 1. Several components of the electric machine 1 such as the stator yoke, teeth, the windings and the electronics 10 are arranged in the volume 15 wherein the teeth and the windings are arranged in the first partial volume 16 and the electronics 10 in the second partial volume 17. Thus, the fluid flow guides 13 and 26 are arranged between the windings and the electronics 10.

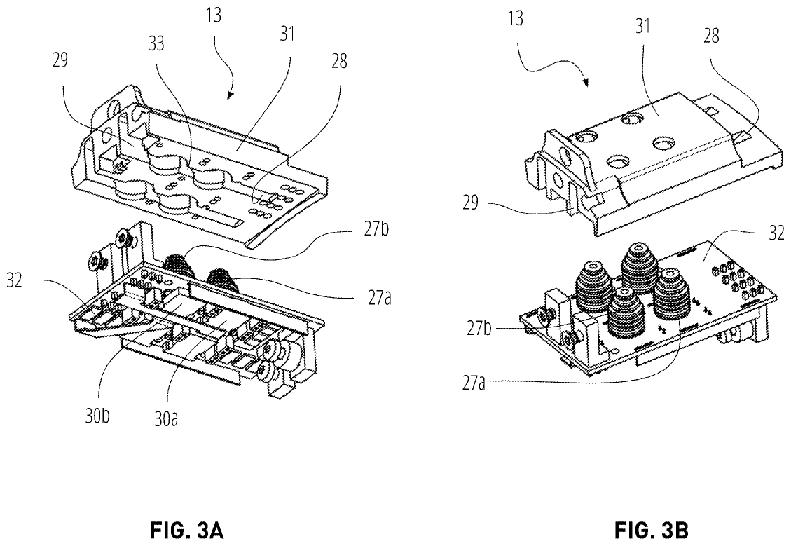

The electronics 10 may comprise control electronics 11 and power electronics. The control electronics 11 is used for controlling the electric machine 1 and comprises a switching circuit and position or speed sensors. The power electronics is used for switching high currents and comprises power electronic components 30a, 30b such as a MOSFET or IGBT (see FIG. 3A, FIG. 3B).

The fluid flow guides such as fluid flow guide 13 and 26 are connected with the intake channel 19 so that the cooling fluid coming from the intake 23 is distributed to all fluid flow guides of the electric machine 1. The intake channel 19 has an annular shape arranged close to inlets of the fluid flow guides.

FIG. 3A and FIG. 3B show the design of the fluid flow guides represented exemplarily by the fluid flow guide 13 in more detail. The fluid flow guide 13 comprises a housing 31 and a board 32. One side of the board 32 is equipped with the power electronic components 30a and 30b. The other side of the board 32 is equipped with heat sinks 27a and 27b. The heat sinks 27a, 27b are mechanically connected with the power electronic components 30a, 30b for example via a heat conductor. I. e. the power electronic components 30a, 30b are in contact with the heat sinks 27a, 27b for transferring heat generated by the power electronic components 30a, 30b to the heat sinks 27a, 27b.

The housing 31 comprises at least one inlet 28 and at least one outlet 29. Inlet 28 and outlet 29 are connected through a flow guide channel 33. The heat sinks 27a and 27b are arranged in the flow guide channel 33 so that the cooling fluid can surround the heat sinks 27a, 27b and dissipate the heat from the heat sinks 27a, 27b for cooling the power electronic components 30a, 30b when the cooling fluids flows past the heat sinks 27a, 27b. The flow guide channel 33 is in alignment with a longitudinal direction being parallel to the rotation axis 2 of the electric machine 1. Thus, the flow direction of the cooling fluid through the fluid flow guide 13 corresponds with the direction of the rotation axis 2.

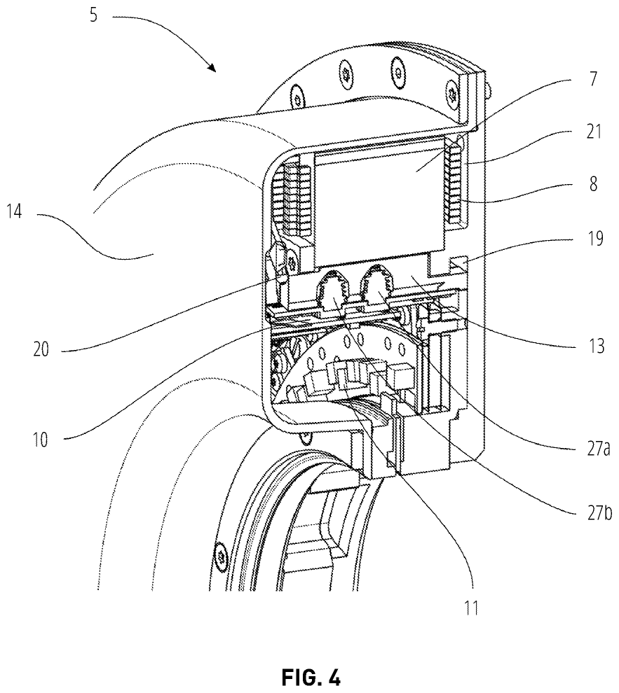

The pressure generated by the pump 34 urges the cooling fluid from the inlet 28 to the outlet 29 of the fluid flow guide 13. As can be seen in FIG. 1 and FIG. 4, the outlet 29 of the fluid flow guide 13 is connected with a connecting channel 20 of the cooling system 12 extending in a radial direction of the electric machine 1 from the outlet 29 to the winding 8 for transferring the cooling fluid from the outlet 29 to the winding 8. Thus, the cooling fluid can be conducted to the windings after a dissipation of the heat generated by electronics and can be used for both cooling the electronics 10 and for cooling the windings.

Analogously, outlets of the other fluid flow guides, as for example fluid flow guide 26, are connected with the connecting channel 20. Optionally, the connecting channel 20 may comprise a flow divider having a separate outlet for at least two windings to conduct the cooling fluid separately between the windings.

Opposite to the connecting channel 20, the cooling system 12 comprises an outtake channel 21. The windings are arranged between the connecting channel 20 and the outtake channel 21. Thus, the cooling fluid can be transferred from the connecting channel 20 along and between the windings to the outtake channel 21. When the cooling fluid flows from the connecting channel 20 to the outtake channel 21 it surrounds the windings and dissipates the heat from the windings for cooling them. Then, the cooling fluid can flow out of the outtake channel 21 through the discharge 24 connected with the outtake channel 21 for conducting the cooling fluid away from the windings.

As can be seen in FIG. 5, the cooling fluid is transferred to the heat exchanger 36 for cooling the cooling fluid after it flows out of the discharge 24. Finally, the cooling fluid is directed back to the reservoir 35.

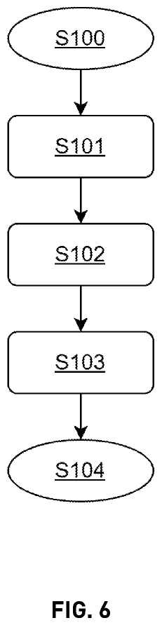

FIG. 6 shows a flow chart of a method for cooling electronics 10 as well as at least one winding 8 of an electric machine 1. The method is described by way of example of several steps without any restriction in respect of that steps. I. e. the number or the order of steps may be adapted, for example single steps may be excluded and/or added and executed earlier or later than described.

The cooling system 12 is configured to carry out the method. The method starts with step S100 and proceeds to step S101.

At step S101, the cooling fluid is conducted through the fluid flow guide 13 for dissipating heat generated by the electronics 10 to the cooling fluid. While the pump 34 pumps the cooling fluid from the reservoir 35 to the intake channel 19 the pump 34 generates a pressure sufficient for conducting the cooling fluid from the intake channel 19 to the outtake channel 21 of the cooling system 12. The heat transferred from the power electronic components 30a, 30b to the heat sinks 27a, 27b is dissipated when the cooling fluid flowing through the fluid flow guide 13 surrounds the heat sinks 27a, 27b.

The method proceeds to step S102 and the cooling fluid is conducted through a connecting channel 20 from the fluid flow guide 13 to the winding 8. Thus, the cooling fluid can be reused for cooling the winding 8 after the heat of the electronics 10, more specific the heat of the power electronic components 30a, 30b, has been dissipated to the cooling fluid.

The method proceeds to step S103 and the cooling fluid is conducted along the winding 8 for dissipating heat generated by the winding 8. Then, the cooling fluid is conducted through a discharge 24 away from the winding 8 back to the reservoir 35. The cooling fluid can be cooled by a heat exchanger 36 to provide a cooled cooling fluid for the pump 34 for dissipating heat.

Finally, the method proceeds to step S104 and ends. Then, the method may be restarted again.

All references cited herein are incorporated herein in their entireties. If there is a conflict between definitions herein and in an incorporated reference, the definition herein shall control.

### LISTING OF DRAWING ELEMENTS

1 electric machine
2 rotation axis
3 rotor
4 magnet
5 stator
6 carrier
7 tooth
8 winding
9 air gap
10 electronics
11 control electronics
12 cooling system
13 fluid flow guide
14 fluid cover
15 volume
16 first partial volume
17 second partial volume
18 outer wall
19 intake channel
20 connecting channel
21 outtake channel
22 winding
23 intake
24 discharge
25 cable duct
26 fluid flow guide
27a heat sink
27b heat sink
28 inlet
29 outlet
30a power electronic component
30b power electronic component
31 housing
32 board
33 flow guide channel
34 pump
35 reservoir
36 heat exchanger

1. An electric machine, comprising
a rotor;
a stator comprising
a carrier;
at least one winding; and
electronics;
the electric machine further comprising a cooling system for cooling the at least one winding and the electronics comprising
a fluid cover attached to the carrier of the stator for enclosing a volume.

2. The electric machine of claim 1, comprising an air gap between the stator and the rotor; wherein
the fluid cover comprises an outer wall extending axially along the air gap.

3. The electric machine of claim 1, wherein the fluid cover is designed as an electromagnetic interference shield.

4. The electric machine of claim 1, wherein the outer wall is electrically limitedly conducting.

5. The electric machine of claim 1, wherein at least one winding is attached to the fluid cover.

6. The electric machine of claim 1, wherein
the at least one winding; and
the electronics
are arranged in the volume.

7. The electric machine of claim 1, wherein the cooling system comprises at least one fluid flow guide arranged in the volume for conducting a cooling fluid.

8. The electric machine of claim 7, wherein the at least one fluid flow guide is arranged between the at least one winding and the electronics.

9. The electric machine of claim 7, wherein the volume comprises a first partial volume and a second partial volume; and wherein
the at least one fluid flow guide is arranged between the first and the second partial volume.

10. The electric machine of claim 9, wherein
the at least one winding is arranged in the first partial volume; and
the electronics is arranged in the second partial volume.

11. The electric machine of claim 7, wherein the at least one fluid flow guide is configured to dissipate heat generated by the electronics to a cooling fluid.

12. The electric machine of claim 7, wherein the at least one fluid flow guide comprises
an inlet;
an outlet; and
at least one heat sink arranged between the inlet and the outlet.

13. The electric machine of claim 12, wherein the at least one heat sink is mechanically connected with the electronics.

14. The electric machine of claim 12, wherein the electronics comprises at least one power electronic component; wherein
the at least one heat sink is mechanically connected to the at least one power electronic component.

15. The electric machine of claim 7, wherein the cooling system comprises
a connecting channel connected with the at least one fluid flow guide for conducting the cooling fluid after a dissipation of the heat generated by electronics to the at least one winding.

16. The electric machine of claim 15, wherein the cooling system comprises
an outtake channel for conducting the cooling fluid away from the at least one winding; wherein
the at least one winding is arranged between the connecting channel and the outtake channel for conducting the cooling fluid along the at least one winding.

17. The electric machine of claim 16, comprising at least two windings; wherein
the connecting channel comprises a flow divider having a separate outlet for each of the at least two windings for conducting the cooling fluid separately between the at least two windings.

18. The electric machine of claim 1 wherein the cooling system comprises
at least two fluid flow guides; and
an intake channel connected with the at least two fluid flow guides for distributing the cooling fluid to the at least two fluid flow guides.

19. The electric machine of claim 18, wherein the at least two fluid flow guides are arranged circumferentially about a rotation axis of the electric machine.

20. A method of cooling electronics and a winding of an electric machine, the method comprising the steps:
Conducting a cooling fluid through a fluid flow guide for dissipating heat generated by the electronics to the cooling fluid;
conducting the cooling fluid through a connecting channel from the fluid flow guide to the winding; and
conducting the cooling fluid along the winding for dissipating heat generated by the winding.

21. (canceled)
